(19) United States
(12) Patent Application Publication
(10) Pub. No.: US 2008/0137058 A1
(43) Pub. Date: Jun. 12, 2008

(54) Beam Separation Apparatus for Monostatic Lidars

(76) Inventor: Stefano Cesare, Torino (IT)

Correspondence Address: K.F. ROSS P.C., 5683 RIVERDALE AVENUE, SUITE 203 BOX 900, BRONX, NY, 10471-0900, US

(21) Appl. No.: 10/541,043

(22) PCT Filed: Nov. 18, 2004
(86) PCT No.: PCT/IT04/00637

§ 371 Date: Jun. 24, 2005

(30) Foreign Application Priority Data
Jun. 16, 2004 (IT) RM2004A000291

(51) Int. Cl. G01S 7/481

(52) U.S. Cl. 356/4.01

(57) ABSTRACT

Monostatic LIDARs use the same telescope to send the laser beam in atmosphere and to collect the backscattered echo. An important element of monostatic LIDARs is the optical separator between the emission and reception paths of the laser beam. By using a system made by a Faraday rotator in combination with two polarizing beam splitters suitably oriented, it is possible to achieve this separation with minimum losses with respect to prior systems using semi-reflective plates and/or polarizing beam splitters in conjunction with quarter-wave plates. The effectiveness of this system does not rely on the maintenance of the polarization status of the laser beam when backscattered by the atmosphere molecules and particles, neither on the reduction of the received laser power relatively to the transmitted one. The system is simple, compact, and can work at several wavelengths of the laser source.

### REFERENCES CITED

### U.S. Patent Documents

U.S. Pat. No. 5,847,815 Aug. 8, 1998 Albouy et al.

### Other Publications

EarthCARE—Earth Clouds, Aerosols and Radiation Explorer, European Space Agency Report SP-1257(1), September 2001.

### BACKGROUND OF THE INVENTION

1. Field of the Invention

The present invention relates to monostatic LIDAR (LIght Detection And Ranging) instruments. The LIDAR is an instrument that makes it possible to determine some properties of the atmosphere (aerosol and water vapour contents, wind velocity, temperature, cloud heights, etc.) by transmitting a laser beam in the atmosphere and analyzing (measuring the time of flight, the Doppler shift, the spectral distribution, etc.) that part of the light which is back scattered towards the instrument.

In a monostatic LIDAR the same telescope is used to send the laser beam in atmosphere and to collect the backscattered echo. An important element of the monostatic LIDAR is the optical system separating the emission path (from the laser source to the telescope) from the reception path (from the telescope to the detectors) of the laser beam. The efficiency of the separation system is measured by the product: η=(transmission of the emission path)×(transmission of the receptions paths).

2. Description of the Prior Art

There are different known methods to separate the emission path from the reception path in a monostatic LIDAR.
a) The simplest system consists of a semi-reflective plate used as amplitude beam splitter (FIG. 1). For the maximisation of the power emitted in atmosphere, the beam splitter must have the largest transmission coefficient T. This is because the power transmitted in atmosphere is the fraction P·T of the power P emitted by the laser source. For the maximisation of the power received by the detector, the beam splitter must have the largest reflection coefficient R=1−T. This is because the power received by the detector is the fraction P′·(1−T) of the power P′ intercepted by the telescope. Whatever value is chosen for T, some power is unavoidably lost in the transmission and the reception path. For instance, if T=0.8, 80% of the laser power is transmitted in atmosphere and only 20% of the backscattered power, intercepted by the telescope, reaches the detector. The efficiency of this separation system is η=T·(1−T) and is maximum (η=0.25) at T=0.5.
b) A more efficient system than that described at paragraph a) is provided by the invention of Albouy et al., where the semi-reflective plate is replaced either by a transparent germanium plate coated by a thin layer of vanadium dioxide or by two transparent glass plated imprisoning liquid ethanol with a suspension of carbon particles. They report an example of 70% transmission of the emission path and 60% transmission of the receptions paths achieved in the infrared using a 0.5 μm layer of vanadium dioxide deposited on a germanium plate. In this case the efficiency of the separation system is η=0.42.
c) Another system consists of a polarizing beam splitter and a quarter-wave plate, as shown in FIG. 2. The laser source must emit a beam linearly polarized in a given plane (for instance the plane parallel to the optical bench). The beam encounters the polarizing beam splitter oriented so as to transmit substantially all the “horizontal” polarization (parallel to the plane of the optical bench) and to reflect all the “vertical” polarization (i.e., a linear polarization in a plane perpendicular to the optical bench). Before entering the transmission telescope, the laser beam crosses a quarter-wave plate that turns the linear polarization into a circular polarization. The laser light backscattered by the atmosphere towards the telescope with circular polarization (of which the telescope intercepts a power amount P′) turns again into a liner polarization after the backwards passage through the quarter-wave plate. The interaction with the atmosphere changes, in the general case, the polarization plane, so that the return laser beam contains a mixture of horizontal and vertical linear polarization (P′=P′_+P′). The polarizing beam splitter reflects the vertical polarization (P′) towards the detector, whereas the horizontal polarization (P′_) transmitted by the polarizing beam splitter is lost. This system is very efficient for the detection of the backscattered light maintaining the same linear polarization (horizontal in this case) of the emitted light (the double pass through the quarter-wave plate turns the horizontal polarization into a vertical polarization), but it does not provide information on the depolarized backscattered light. This information is important in several LIDAR applications since the amount of depolarization is related to the shape of the particles that have backscattered the laser beam (for instance the presence of ice particles in a cloud can be deduced from the depolarized LIDAR echo).
d) A fourth system consists of a combination of a semi-reflective plate and a polarizing beam-splitter plus quarter-wave plate as shown in FIG. 3. By using this system, the depolarized backscattered light can also be detected. This is because a fraction P′_·(1−T) of horizontally polarized light transmitted by the polarizing beam splitter in the reception path is reflected towards a second detector by the semi-reflective plate. Here the transmission of the emission path is limited by the transmission coefficient T of the semi-reflective plate. The transmission of the reception path is substantially 100% (disregarding the limited intrinsic transmissivity of the optical elements), for the backscattered light maintaining the same linear polarization of the emitted light (η=T), and is (1−T) for the depolarized backscattered light (η=T·(1−T)). This system has been adopted in the configuration of the ATmospheric backscatter LIDAR (ALTID) of the EarthCARE mission of the European Space Agency (ESA Report SP-1257(1), September 2001).

The invention disclosed here overcomes the above-mentioned limitations, by reducing at the minimum the power losses in the transmission and reception optical path of a monostatic LIDAR, regardless of the power and polarization status of the backscattered light. The limitations of the beam separation systems a), b), d) are overcome because the invention uses polarizing beam splitters for routing the light towards the telescope and the detectors. These elements, suitably combined with a Faraday rotator, make it possible to send substantially all the light in the desired direction. On the contrary, the semi-reflective plate or the devices of the system b) send part of the light in an unwanted direction at any crossing. The limitation of the system c) is overcome by using a second polarizing beam splitter and a second detector, that make it possible to collect also the light not routed towards the first detector by the first polarizing beam splitter.

### SUMMARY OF THE INVENTION

The main object of the present invention is to provide a system for the optical separation of the emission and reception light paths of a monostatic LIDAR, comprising a polarizing beam splitter followed by a Faraday rotator and a second polarizing beam splitter, suitably oriented.

A Faraday rotator is a non-reciprocal optical device that uses a magnetic field applied to a suitable crystal to rotate always in the same direction the polarization plane of a light beam passing through it, regardless of the versus in which the Faraday rotator is crossed by the light. The Faraday rotator described in the present invention rotates the polarization plane through an angle of 45° (for example, in counter clockwise direction) at any crossing.

The two polarizing beam splitters are rotated through an angle of 45° one relative to the other, around the laser beam propagation direction.

A monostatic LIDAR, using the apparatus disclosed here, is substantially free of power losses along both the emission and reception paths. The only power losses are due to the limited intrinsic transmissivity of the various optical elements. These losses are unavoidably present in any type of LIDAR and can be minimised by using optical materials and coatings (polarizing, antireflection) tailored to the laser source wavelength.

Another remarkable feature of a LIDAR based on the present invention is the transmission in atmosphere of a laser beam with linear polarization.

A further advantage of this invention is that substantially no fraction of the backscattered light (coming from the atmosphere or from the optical elements after the second polarizing beam splitters) reaches the laser source. The apparatus disclosed here is also, by its nature, an optical isolator, so that no additional devices of this kind are necessary to avoid light feedbacks into the laser (these feedbacks degrade the frequency stability of the source).

Finally, this apparatus is simple and only made by solid-state elements. This makes it suitable to space applications, carried on board a spacecraft.

### BRIEF DESCRIPTION OF THE DRAWINGS

FIG. 1, reflecting the state of the art, shows the basic scheme of a monostatic LIDAR using a semi-reflective plate to separate the beam emitted in atmosphere from the received backscattered echo.

FIG. 2, reflecting the state of the art, shows the basic scheme of a monostatic LIDAR using a polarizing beam splitter and a quarter-wave plate to separate the beam transmitted in atmosphere from the received backscattered echo.

FIG. 3, reflecting the state of the art, shows the basic scheme of a monostatic LIDAR using a semi-reflective plate, a polarizing beam splitter and a quarter-wave plate to separate the beam transmitted in atmosphere from the received backscattered echo.

FIG. 4 shows a scheme of a monostatic LIDAR using the beam separation system composed by a Faraday rotator and two polarizing beam splitters, according to the present invention.

FIG. 5 illustrates the relative arrangement of the polarizing beam splitters and the Faraday rotator, according to the present invention, and their working principle in the emission path of the monostatic LIDAR of FIG. 4.

FIG. 6 illustrates the working principle of the beam separation system, according to the present invention, in the reception path of the monostatic LIDAR of FIG. 4.

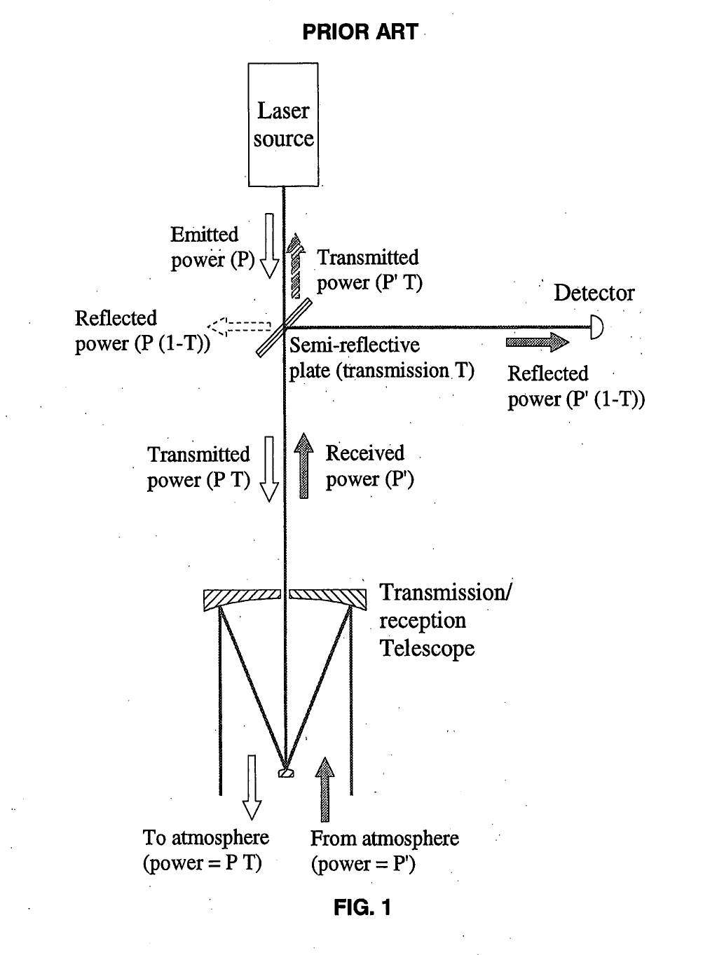

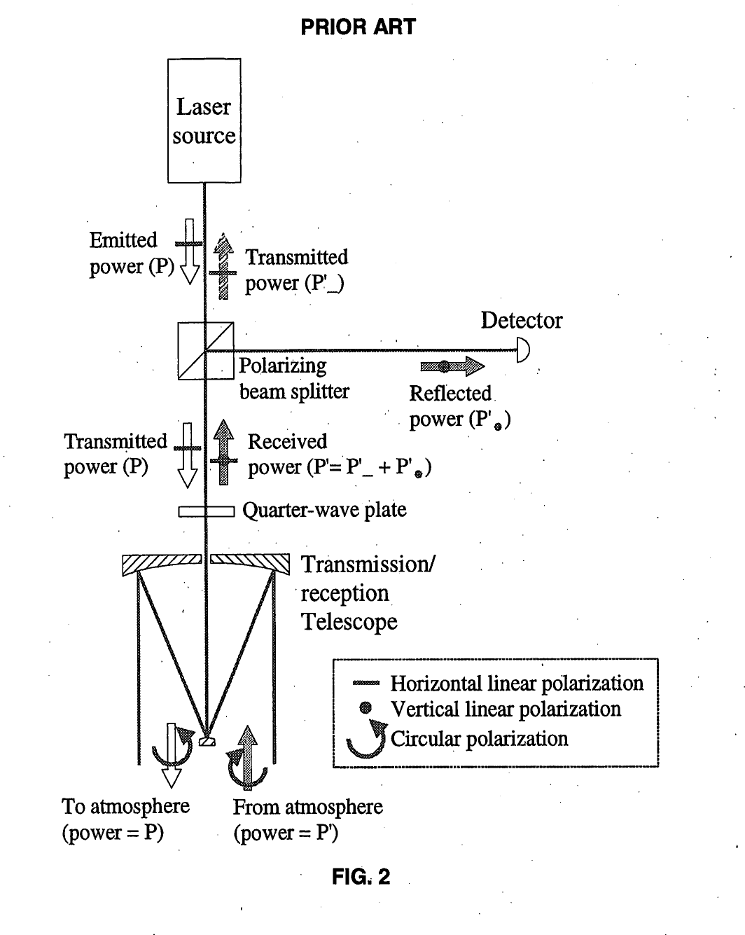

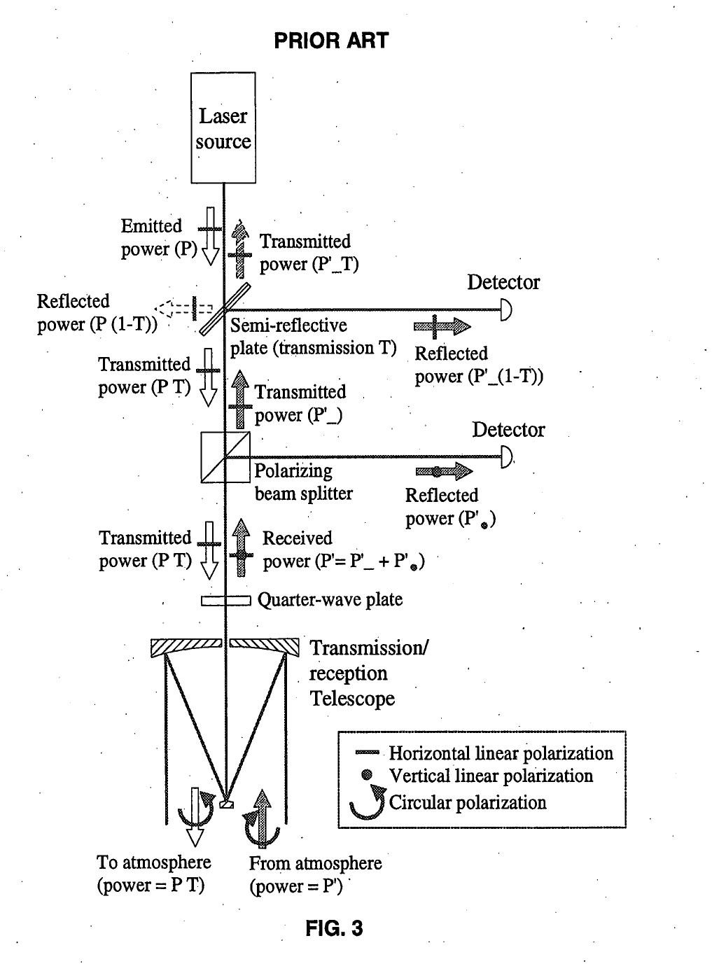

### DESCRIPTION OF THE PREFERRED EMBODIMENTS

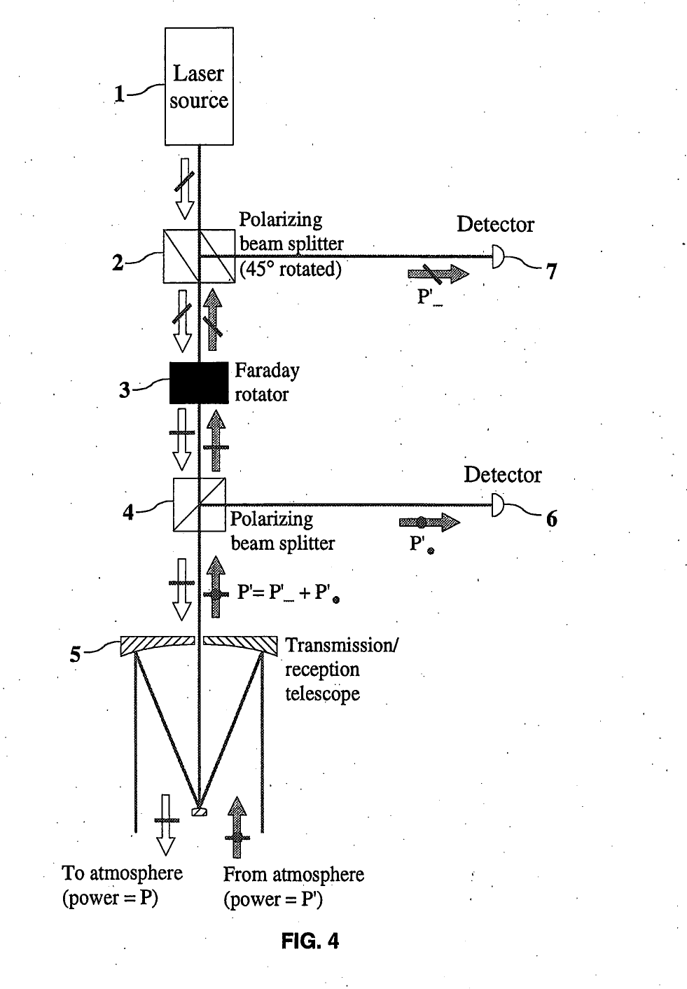

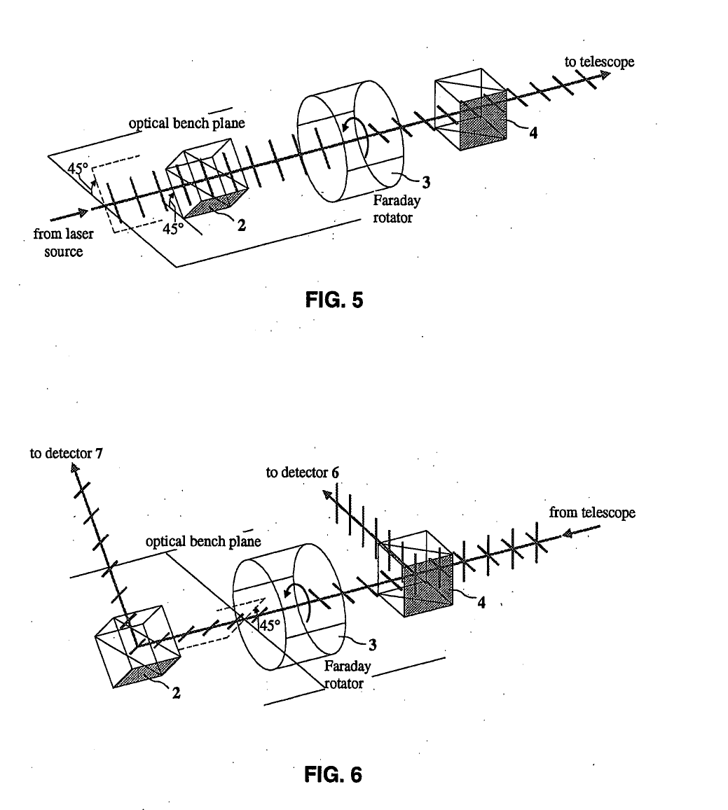

FIG. 4 shows the scheme of a monostatic LIDAR including the beam separation system, according to the present invention. The laser source 1 emits a beam of power P, with a linear polarization lying in a plane rotated through an angle of 45° with respect to the plane of the optical bench (assumed as reference plane). The beam encounters the first polarizing beam splitter 2, also rotated through an angle of 45° with respect to the optical bench, so that the incoming polarized light is substantially all transmitted. The correct orientation of the polarizing beam splitter 2 is shown in FIG. 5. The Faraday rotator 3 is placed after the polarizing beam splitter 2. It rotates the laser beam polarization plane through an angle of 45° in counter clockwise direction so as to make it parallel to the optical bench plane (“horizontal” polarization). The third polarizing beam splitter 4 is placed after the Faraday rotator 3 with its faces parallel to the optical bench, oriented so that the horizontal polarized light is substantially all transmitted. The correct orientation of the polarizing beam splitter 4 is shown in FIG. 5. The telescope 5 then transmits the laser beam towards the atmosphere.

Along the path from the laser source to the telescope, no power losses occur apart those due limited intrinsic transmissivity of the various optical elements. The amount of these losses is very low. For instance, at the fundamental emission wavelength of a Nd:YAG laser (λ=1064 nm), typically used in LIDARs, the transmission efficiency of a Faraday rotator is greater than 98%. A polarizing beam splitter has a typical transmission efficiency greater than 95% for the p-polarization (the polarization of the light crossing the two beam splitters along the transmission path). An anti-reflection coating tailored to this wavelength can limit the power losses to less than 0.25% at each crossing of an optical surface by the laser beam. The total transmission efficiency of the emission path of the LIDAR of FIG. 4 is therefore greater than 87% (from the laser source to the telescope), at λ=1064 nm.

The laser light backscattered from the atmosphere and intercepted by the telescope 5 contains, generally speaking, a mixture of horizontal and vertical linear polarization. By denoting with P′ the power of the backscattered echo collected by the telescope, we have in the general case: P′=P′_+P′, where the symbol “_” denotes the light with “horizontal” polarization plane and the symbol “” denotes the light with “vertical” polarization plane relative to the optical bench plane. The polarizing beam splitter 4 reflects the vertical polarization (P′) towards a first detector 6 and transmits the horizontal polarization (P′_). This transmitted beam crosses backwards the Faraday rotator 3, which rotates its polarization plane through an angle of 45° in counter clockwise direction. When it leaves the Faraday rotator, the backward travelling beam has a polarization plane perpendicular to that of the forward travelling beam and, when it encounters the polarizing beam splitter 2, is substantially all reflected towards the second detector 7.

The return path of the laser beam from the telescope to the detectors is shown in FIG. 6. Even along this path, the power losses are reduced to the minimum level corresponding to the transmissivity of the optical elements. For example, at the wavelength λ=1064 nm, a polarizing beam splitter has a reflection efficiency that can be larger than 99.5% for the s-polarization (the “vertical” polarization of the light crossing the two beam splitters along the reception path). The total transmission efficiency of the reception path of the LIDAR of FIG. 4 is therefore greater than 99% (from the telescope to detector 6) and greater than 95% (from the telescope to detector 7), at λ=1064 nm. Therefore, at this wavelength, the efficiency of this separation system is η>0.87×0.95 (that is, η>0.82), for the backscattered light maintaining the same linear polarization of the emitted light (the part of the emitted light that crosses two times the Faraday rotator in the round-trip path), and η>0.87×0.99 (that is, η>0.86) for the depolarized backscattered light, considering the limited intrinsic transmissivity of the optical elements.

1. An apparatus for the optical separation of the emission and reception light paths of a monostatic LIDAR, said apparatus comprising:
a laser source (1) emitting a beam of light with linear polarization;
a first polarizing beam splitter (2) oriented to transmit towards the Faraday rotator (3) substantially all the light emitted by said source (1);
a Faraday rotator (3) applying a 45° polarization plane rotation;
a second polarizing beam splitter (4), rotated through an angle of 45° with respect to said first polarizing beam splitter (2), around the light propagation direction;
an optical system (5), or telescope, for the transmission and reception of the light to/from the atmosphere;
two detectors (6) and (7), with related electronics, collecting the backscattered light collected by said optical system (5) and routed towards them by the two polarizing beam splitters (2) and (4);
characterized in that:
substantially all the light emitted by said laser source (1) is routed by the two polarizing beam splitters (2) and (4) and by the Faraday rotator (3) towards the telescope (5) and not in other directions;
substantially all the backscattered light collected by said optical system (5) is routed by the two polarizing beam splitters (2) and (4) and by the Faraday rotator (3) towards the detectors (6) and (7), and not in other directions.

2. The apparatus claimed in claim 1, characterised in that said apparatus is only made by solid-state elements.

3. The apparatus claimed in claim 1, characterised in that:
the light sent in the atmosphere is linearly polarized; and
said laser source is also isolated from the light backscattered by any element placed after said apparatus.

4. A method for optical separation of the emission and reception light paths of a monostatic LIDAR, based on the apparatus claimed in claim 1, consisting of the following steps:
sending in the atmosphere a light having a linear polarization; and
maximising the detection of the backscattered light maintaining the same linear polarization as the emitted light after the back reflection by the atmosphere.
